(19) United States
(12) Patent Application Publication
(10) Pub. No.: US 2002/0120706 A1
(43) Pub. Date: Aug. 29, 2002

(54) Method for determining master or slave mode in storage server subnet

(76) Inventor: Ciaran Murphy, Dublin (IE)

Correspondence Address: NIXON & VANDERHYE P.C., 8th Floor, 1100 North Glebe Road, Arlington, VA, 22201-4714, US

(21) Appl. No.: 09/897,119

(22) Filed: Jul. 3, 2001

(30) Foreign Application Priority Data
Feb. 28, 2001 (GB) 0104908.9

(51) Int. Cl. G06F 15/16

(52) U.S. Cl. 709/208; 709/203

(57) ABSTRACT

A plurality of storage servers (5, 7, 8, 9) are connected in a subnet (1) that is connected to a main network (2) via a single one of the storage servers (5). All traffic from the main network passes through the single storage server which operates in file mode and has an internal protocol server, such as a DHCP server, turned on. The other servers operate in a slave mode with their internal protocol servers turned off and function at block level.

An automated master/slave recognition system operates on start up. All the storage servers power up as slaves requesting IP addresses. The storage server connected to the main network recognizes that it has received its address from the main network by virtue of receipt of standard protocol. It then turns on its own internal protocol server and adopts master mode. The master servers internal protocol server sends out the IP addresses for the storage subnet in a modified protocol, and on receipt of these the other storage servers remain in slave mode.

### FIELD OF INVENTION

This invention relates to networks and to network attached storage, with particular, but not exclusive, usefulness in local area networks.

### BACKGROUND OF THE INVENTION

Networks generally consist of a number of devices such as workstations, personal computers, servers, hubs, routers, bridges and switches linked together by physical cable or wireless links. The devices on the network operate in accordance with a protocol to enable recognition of communicating devices and control of the data or traffic between them. Networks may take various forms such as a local area network (LAN) or a wide area network (WAN).

There is a constant demand for increasing levels of storage and for flexible or expandable storage. It is desirable for devices to be able to configure themselves automatically, e.g. on start up, or after a new deployment for their mode of operation without the intervention of a network manager.

### SUMMARY OF THE INVENTION

The present invention is directed towards providing a Storage Area Network in which a plurality of storage servers one or more of which are dual-purpose or dual-mode, are interconnected in a sub-network that appears to the main network as a single storage area, and to a method of enabling a storage server to determine automatically if it is directly connected to the main network and is to function as a master server of the subnet or whether it is a slave server. A dual-mode storage is one that can operate as either a file server or as a block storage device. There may be instances in complex networks or in clusters where more than one server is a master or where a cluster operates collectively as a master.

Accordingly the invention provides a storage area network comprising a plurality of storage servers, a first of which is directly connected to a main network and others of which are connected to the first storage server, the first storage server having an internal protocol server that inserts an identifier into the protocol package so that the protocol package differs from the protocol of the main network and the first storage server supplies the protocol to the other storage servers which recognise the identifiers.

The invention also provides a method of establishing mode of operation for a storage server in a storage area network. The storage area network comprising a plurality of storage servers a first of which is directly connected (as herein defined) to a main network and others of which are connected to the first storage server, and said server for which the mode of operation is to be established being capable of operating in a master or slave modes, the method comprising starting up, examining an incoming event to determine if it corresponds to network protocol or contains a particular protocol modification, and when the event corresponds to network protocol without the particular modification proceeding with further operation in master mode and inserting the particular protocol modification into events destined to other storage servers, or when the incoming event contains the particular protocol modification, proceeding with further operation in slave mode.

Within the context of the disclosure ‘directly connected’ means such that normal events or protocols are experienced. There may be switches or other intervening devices, and the connection may take any form.

### BRIEF DESCRIPTION OF THE DRAWINGS

The intention is now described by way of example with reference to the accompanying drawings in which

FIG. 1 is a simplified schematic illustration of a local area network incorporating an embodiment of the invention

FIG. 2 is an illustration showing an embodiment with a master cluster

FIG. 3 is a diagram of DHCP message format

FIG. 4 is a flow diagram of the startup procedure and master/slave recognition

### DETAILED DESCRIPTION OF PREFERRED EMBODIMENT

One of the benefits of networks is the ability to access data remotely from its storage location and storage servers are therefore very significant components. There is constant pressure to increase and upgrade storage facilities and to link together storage servers. When servers are changed or switched off it is desirable for the servers to be able to establish automatically how they are connected.

In the present invention a plurality of storage servers are interconnected in the form of a network or subnet that is seen by the network to which it is attached as a single storage area. A particularly suitable form of server for this purpose is one that is dual-mode and which can be interconnected to other similar servers via Ethernet links.

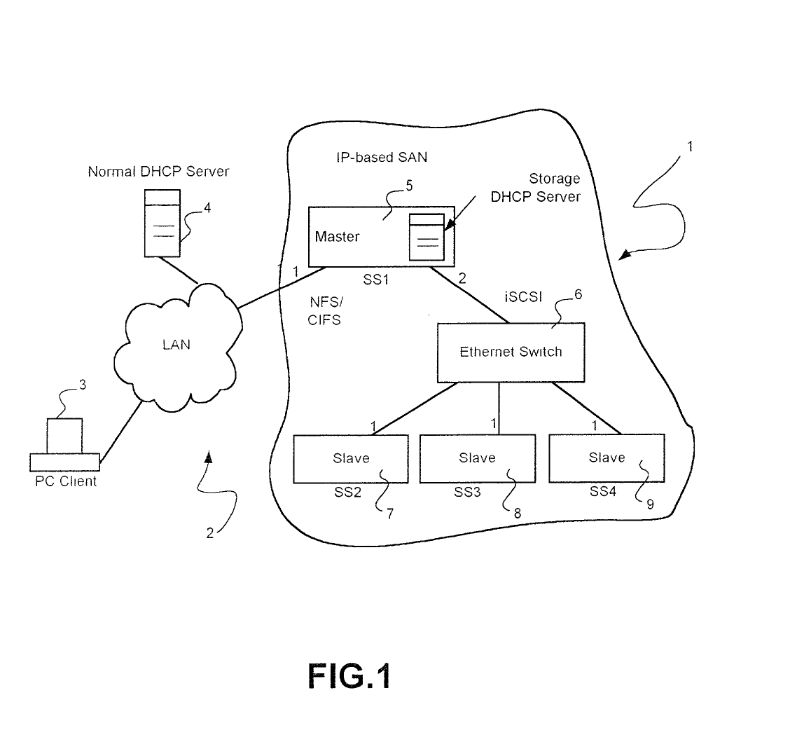

Referring now to FIG. 1 such a storage area network 1 is shown connected to a local area network (LAN) 2. Also connected to the LAN are other devices represented in the drawing by a PC client 3 and a DHCP Server 4. In real circumstances LANs are usually very much more complex and include many more attached devices including switches and hubs. In many instances the networks are managed by a supervisor and some of the individual devices may also be managed.

Within the storage area network (SAN) a first storage server 5 is connected via a switch 6 to a plurality of other storage servers 7, 8 and 9.

In the preferred embodiment the storage servers are preferably all dual mode, identical and of a type that can be interconnected via Ethernet links although other forms of interconnection and different servers may be used as long as they can respond to the protocol that is used. In the example now described dynamic host communication protocol (DHCP) is used, but the invention is not limited to this protocol.

The storage servers have multiple Ethernet ports, but storage server 5 does not route any packets between its ports but requires an output address per port. Therefore only storage server 5 is directly accessed from the LAN and all the other storage servers are accessed indirectly via the storage server 5.

In operation storage server 5 operates in a “master” mode in which it has its internal DHCP server turned on and in which it has a block-level view of all the storage within the SAN and operates in file-level mode. The other storage servers 7, 8 and 9 operate in a “slave” mode in which they have their internal DHCP servers turned off and operate in block-level mode.

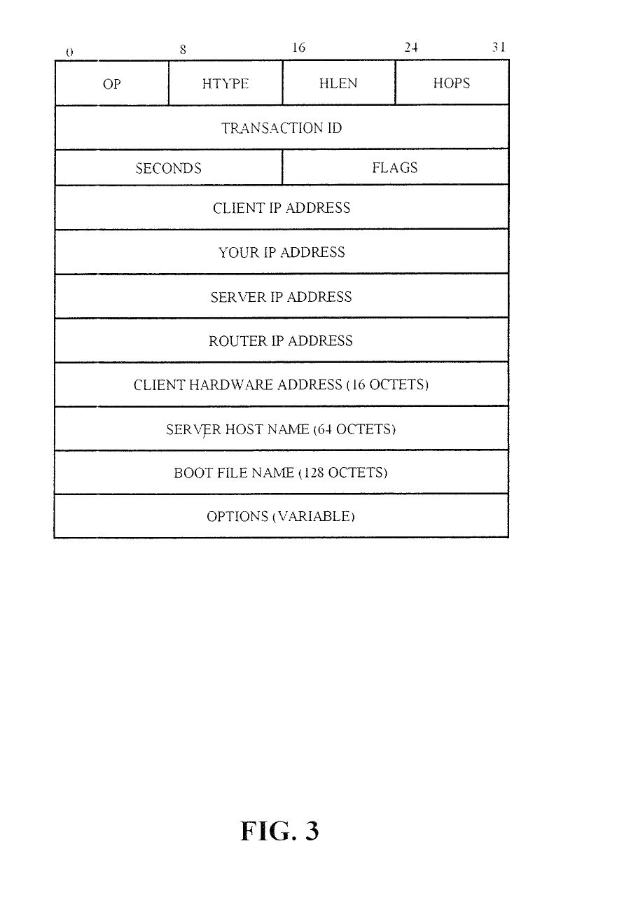

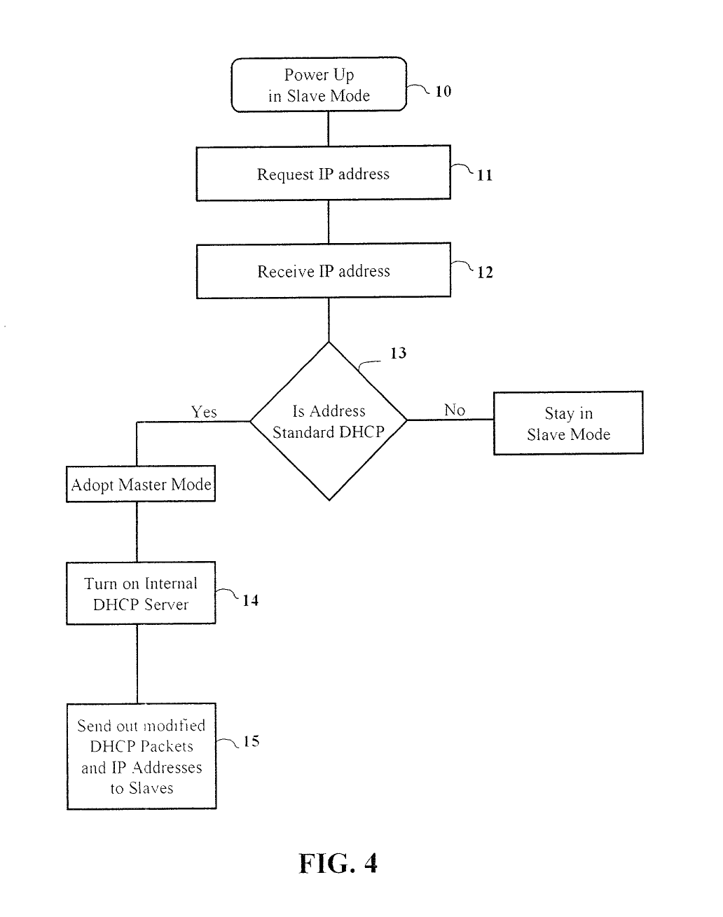

As far as another device on the LAN is concerned, such as PC client 3, it sees the aggregated storage of the SAN as a single large storage volume. When it sends file input/output requests (using any appropriate protocol such as NFS or CIFS) to the SAN these are received by the master storage server 5 which converts the file-level request into a block-level request and sends this to the appropriate slave (7, 8 or 9) which then performs the relevant block-level read or write to its internal storage. The block-level protocol is usually SCSI over IP, also termed iSCSI. IP-based traffic from the LAN (such as DHCP from the LAN) does not appear on the SAN due to the passage via the master 5, although as indicated later DHCP packets will appear on the SAN from the master server. It is desirable for the storage servers in the SAN to be able to determine for themselves whether they are the master or a slave, and hence whether to operate in file-level or block-level mode. The present invention modifies an aspect of the normal protocol on the LAN (for example the DHCP protocol or alternatively BOOTP or any other), so that it appears differently when seen on the SAN. For the purpose of illustration, a mechanism for this is explained further with reference to DHCP protocol, and FIGS. 3 and 4.

FIG. 3 shows the DHCP message format, in which the ‘OPTIONS’ portion can contain a variable message. (The DHCP OPTIONS field in fact has the same format as the VENDOR SPECIFIC AREA of a BOOTP message, so that area can be utilised in BOOTP protocol similarly to the following explanation for DHCP). The OPTIONS field may contain a plurality of entries. Each item contains a one-octet type an optional one-octet length, and a multi octet value. One type value (43 decimal) is defined as the Vendor-Specific option. This may be used for transferring vendor-specific information between the DHCP client and DHCP server in either direction. Within an implementation of the invention utilising DHCP this type value may be used to identify that the DHCP packet has been generated by a DHCP server within a storage area network. It will be appreciated that other modifiable parts of the protocol or other events may be used in the procedure taught in this invention.

An automated master/slave recognition procedure utilising this modified protocol is now described with reference to FIG. 4.

On power up all the storage servers in the SAN are configured to power up in slave mode with their internal DHCP servers turned off, as indicated by box 10.

When a new device is connected to an existing network, or when it is started up after being down, it sends out a request to the network for an IP address. There are various schemes by which addresses are allocated, one of which is via DHCP, another of which is via a discovery mechanism, for example a process known as ICMP Echo Request and Reply. Having been turned on, the storage servers will all request IP addresses, as shown by box 11.

Box 12 represents the step of receiving the IP address, which is followed by the step of the server checking the DHCP options field, or such other field and protocol or event as has been modified.

The storage server that is directly connected to the LAN has its IP address assigned via the LAN and detects this by absence of the vendor-specific option in a DHCP lease message, or by detecting manual settings of the IP address. Therefore it recognises it must be the master, and this corresponds to the YES answer to box 13.

Having determined that it is the master, the storage server connected to the LAN turns on its own internal DHCP server (box 14), and also assigns a fixed IP address to its Ethernet port on the storage subnet. The internal DHCP server of the master then sends out packets on the storage subnet containing the modified protocol.

The other storage servers which are still operating in slave mode then obtain their IP addresses on the storage subnet (SAN) from the DHCP server in the master. Thus at the box 13 step, these servers detect the special signal in the DHCP packet, a NO response to box 13, and remain in slave mode.

Although the embodiment described is in the context of a LAN using DHCP and iSCSI, other forms of network may utilise the SAN described and its operation. Likewise other protocols or events may be used and modified in a corresponding way. In configurations where more than one storage server is to operate in master mode, the other master server will also detect that they are directly connected to the network. In some instances a plurality of servers may operate together in a master cluster to provide resilience so that in the event of a failure of one of them another takes over.

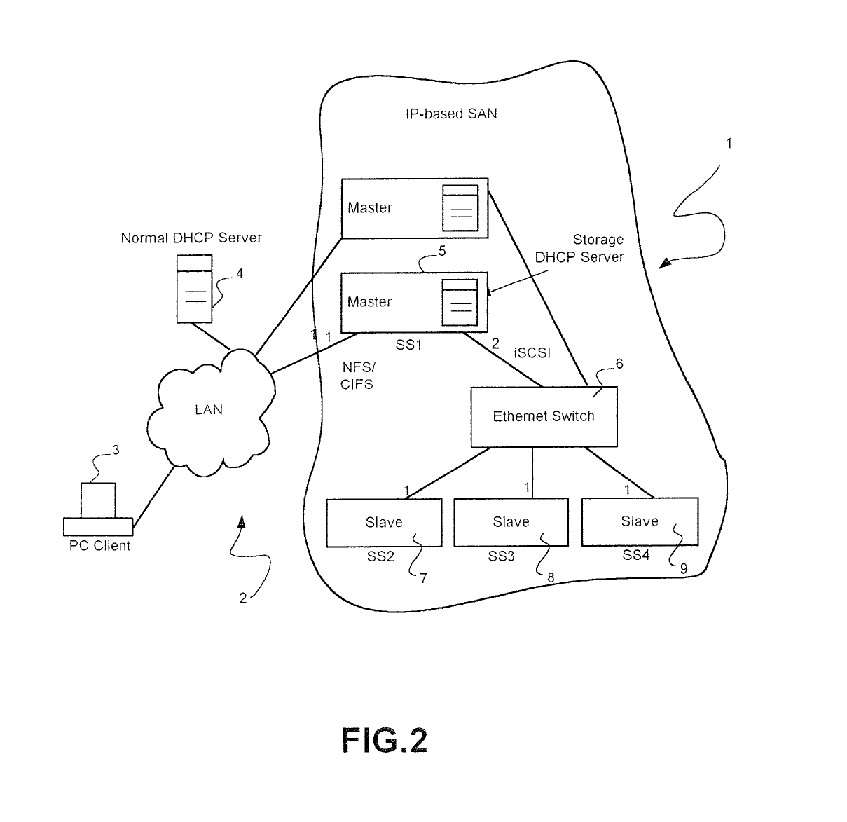

With a cluster, all the servers in the cluster are connected to the main network and so experience the event or protocol on that network. The master cluster can be regarded as parallel connections between the LAN 2 and switch 6 of FIG. 1 and will run cluster software. FIG. 2 shows an arrangement with two servers in a master cluster. They may be interconnected so as to provide their cooperative or resilient functions. The interconnection protocol or cluster software may include only allowing one ‘main’ master tuning on its DHCP server to send out the modified protocol, and for other servers of the cluster to run in file mode but only to turn on their DHCP servers in the event of a failure such that they are to become the new main master.

It will be appreciated that start up in file level mode is also possible with the adoption of master mode corresponding to turning on the internal DHCP server. Detecting the modified protocol would then induce a switch to slave or block level mode.

1. A storage area network comprising a plurality of storage servers, a first of which (5) is directly connected (as herein defined) to a network (2) and others of which (7, 8 and 9) are connected via the first storage server, the first storage server having an internal protocol server that inserts an identifier into the protocol package so that the protocol package differs from the protocol of the main network and the first storage server supplies the protocol to the other storage servers which recognise the identifiers.

2. A storage area network according to claim 1 in which the first storage server operates in a master mode which includes having its internal protocol server turned on and operating at file level, and said other storage servers operate in a slave mode which includes operating at block-level.

3. A storage area network according to claim 2 in which the rest of the storage servers also have an internal protocol server, and the slave mode further includes the internal protocol servers being inoperative.

4. A storage area network according to any preceding claim in which the first storage server is configured to start up with its internal protocol server inoperative and upon receipt of a standard event from the main network, the internal protocol server commences operation.

5. A storage area network according to any preceding claim in which the storage servers are similar and interconnected via Ethernet connection.

6. A storage area network according to any preceding claim in which a cluster of storage servers are directly connected to the main network and to said other storage servers and only one of said cluster inserts the identifier into the protocol package.

7. A storage area network according to claim 6 in which the storage servers of the cluster all operate in file level mode.

8. A storage network according to claim 6 or claim 7 in which the cluster of storage servers establish which one is to insert the identifier.

9. A method of establishing mode of operation for a storage server in a storage area network, the storage area network comprising a plurality of storage servers a first of which (5) is directly connected (as herein defined) to a main network (2) and others of which (7, 8 and 9) are connected to the first storage server, and said server for which the mode of operation is to be established being capable of operating in a master or slave modes, the method comprising
starting up,
examining an incoming event to determine if it corresponds to network protocol or contains a particular protocol modification, and
when the event corresponds to network protocol without the particular modification proceeding with further operation in master mode and inserting the particular protocol modification into events destined to other storage servers,
or when the incoming event contains the particular protocol modification, proceeding with further operation in slave mode.

10. A method according to claim 9 in which the particular protocol modification comprises a specific type value within a variable field.

11. A method according to claim 9 or claim 10 in which the servers start up with their internal protocol servers turned off an when an event corresponding to network protocol without modification is detected, the server turns on its internal protocol servers.

12. A method according to any of claims 9 to 11 in which the servers start up in one of block level mode or file level mode, when an event corresponding to network protocol without modification is detected, the server proceeds further in file level mode and when the event detected contains the modification the server proceeds further in block level mode.

13. A method according to any of claims 9 to 12 in which a cluster of storage servers are directly connected to the main network and to said other storage servers and upon detection of an event corresponding to network protocol without modification each of said cluster of storage servers proceeds with further operation in file-level mode and one of the cluster inserts the identifier.

14. A method of establishing mode of operation for a device capable of functioning in a master or slave mode, the device to operate in master mode when connected to experience events on a network and to operate in slave mode when a device operating in master mode is interposed between it and connection to the network,
the method comprising powering up the device, establishing whether a particular event corresponds to an event on the network or to a modified event, and when the event corresponds to an event on the network adopting master mode operation or when the particular event corresponds to a modified event, adopting slave mode of operation.

15. A method according to any of claims 9 to 14 in which the event is the receipt of an IP address.
